(19) United States
(12) Patent Application Publication
(10) Pub. No.: US 2025/0294431 A1
(43) Pub. Date: Sep. 18, 2025

(54) COMMUNICATION CONTROL METHOD, COMMUNICATION MASTER DEVICE, AND SYSTEM IN LOCAL AREA NETWORK

(71) Applicant: GUANGZHOU YAJIANG PHOTOELECTRIC EQUIPMENT CO., LTD., Guangzhou (CN)

(72) Inventors: Zhiman Chen, Guangzhou (CN); Rongfeng Huang, Guangzhou (CN); Yunchou Chen, Guangzhou (CN)

(21) Appl. No.: 19/224,723

(22) Filed: May 31, 2025

Related U.S. Application Data
(63) Continuation-in-part of application No. PCT/CN2024/112978, filed on Aug. 19, 2024.

(30) Foreign Application Priority Data
Oct. 19, 2023 (CN) 202311360103.4

(51) Int. Cl. H04W 48/10; H04W 28/02; H04W 56/00; H04W 84/12

(52) U.S. Cl. CPC H04W 48/10; H04W 28/0215; H04W 56/001; H04W 84/12

(57) ABSTRACT

Provided are a communication control method, a communication master device, and a system in a local area network. The method includes: sending, every first preset duration, a broadcast search instruction to each slave device for a device search, whereby each slave device randomly generates a first timing time slice, and makes a response after timing of the first timing time slice ends; after the device search is completed, sending a broadcast access instruction to each slave device, whereby each slave device randomly generates a second timing time slice, and makes a response after timing of the second timing time slice ends; and after device access is completed, sending, by a master device, a synchronization instruction to each slave device, whereby each slave device randomly generates a third timing time slice, and makes a response after timing of the third timing time slice ends.

### CROSS REFERENCE TO RELATED APPLICATIONS

The present application is a Continuation-In-Part application of PCT Application No. PCT/CN2024/112978 filed on Aug. 19, 2024, which claims the benefit of Chinese Patent Application No. 202311360103.4 filed on Oct. 19, 2023. All the above are hereby incorporated by reference in their entirety.

### TECHNICAL FIELD

The present disclosure relates to the field of Ethernet applications, and in particular, to a communication control method, a communication master device, and a system in a local area network.

### BACKGROUND

In an industrial application of Ethernet communication, in order to ensure a speed and stability of signal transmission in a local area network, a local area network with wired communication is usually used. Industrial Ethernet communication typically uses an embedded system to develop software and hardware for the Ethernet communication, and a communication speed and capability are affected by hardware of the embedded system used. In an Ethernet application based on the embedded system, if a system network has more than one thousand node devices and a network host broadcasts access to all nodes by using a User Datagram Protocol (UDP), all nodes in the local area network make a response simultaneously. If a response speed of the host is not fast enough, a response instruction from a slave device is lost. When being triggered by a synchronization signal, the slave device also makes a response synchronously, forming a network packet storm instantaneously. This causes network congestion or data loss due to timeout. How to effectively reduce a probability of a network storm is an urgent problem that needs to be solved.

### SUMMARY

The present disclosure provides a communication control method, a communication master device, and a system in a local area network. The communication control method can effectively reduce a probability of a network storm, avoid a data loss, reduce a network communication risk, and improve efficiency and stability of data communication.

An embodiment of the present disclosure provides a communication control method in a local area network, including:
sending, every first preset duration, a broadcast search instruction to each slave device for a device search, whereby each slave device randomly generates a first timing time slice after receiving the broadcast search instruction, and makes a response to the broadcast search instruction after timing of the first timing time slice ends;
after the device search is completed, sending a broadcast access instruction to each slave device for device access, whereby each slave device randomly generates a second timing time slice after receiving the broadcast access instruction, and makes a response to the broadcast access instruction after timing of the second timing time slice ends; and
after the device access is completed, sending a synchronization instruction to each slave device, whereby each slave device randomly generates a third timing time slice after receiving the synchronization instruction, and makes a response to the synchronization instruction after timing of the third timing time slice ends.

Further, the communication control method in a local area network further includes:
receiving the response made by the slave device to the broadcast search instruction; and
after receiving the response made by the slave device to the broadcast search instruction, recording corresponding information of the slave device, and delivering a muting instruction to the slave device, whereby the slave device no longer responds to the broadcast search instruction sent by a master device after receiving the muting instruction.

Further, the communication control method in a local area network further includes:
recording duration after the broadcast access instruction is sent, and ending a broadcast search for the slave device when the duration is greater than preset device response duration, where the preset device response duration is greater than the first preset duration; or ending a broadcast search for the slave device when the duration is less than the preset device response duration but responses made by all slave devices to the broadcast access instruction have been received.

Further, timing duration of the first timing time slice ranges from 1 ms to N ms, timing duration of the second timing time slice ranges from 1 ms to N ms, and timing duration of the third timing time slice ranges from 1 ms to Mms, where 1<M<N.

Further, each slave device is connected to a corresponding switch, and each slave device receives the broadcast search instruction, the broadcast access instruction, and the synchronization instruction through the corresponding switch.

On a basis of the above method embodiments, the present disclosure correspondingly provides a communication master device in a local area network, including a processor, a memory, and a computer program stored for the memory and configured to be executed by the processor. The processor executes the computer program to implement the communication control method in a local area network.

On a basis of the above communication master device, the present disclosure correspondingly provides a communication control system for a local area network including a communication master device, including a communication master device, and a plurality of slave devices, where
the communication master device is configured to send, every first preset duration, a broadcast search instruction to each of the slave devices for a device search;
each of the slave devices is configured to randomly generate a first timing time slice after receiving the broadcast search instruction, and make a response to the broadcast search instruction after timing of the first timing time slice ends;
the communication master device is further configured to: after the device search is completed, send a broadcast access instruction to each of the slave devices for device access;
each of the slave devices is further configured to randomly generate a second timing time slice after receiving the broadcast access instruction, and make a response to the broadcast access instruction after timing of the second timing time slice ends;
the communication master device is further configured to: after the device access is completed, send a synchronization instruction to each of the slave devices; and
each of the slave devices is further configured to randomly generate a third timing time slice after receiving the synchronization instruction, and make a response to the synchronization instruction after timing of the third timing time slice ends.

Further, the communication master device is further configured to:
receive the response made by the slave device to the broadcast search instruction; and
after receiving the response made by the slave device to the broadcast search instruction, record corresponding information of the slave device, and deliver a muting instruction to the slave device, whereby the slave device no longer responds to the broadcast search instruction sent by the communication master device after receiving the muting instruction.

Further, the communication master device is further configured to:
record duration after the broadcast access instruction is sent, and end a broadcast search for the slave device when the duration is greater than preset device response duration, where the preset device response duration is greater than the first preset duration; or end a broadcast search for the slave device when the duration is less than preset device response duration but responses made by all the slave devices to the broadcast access instruction have been received.

Further, the communication control system for a local area network further includes a plurality of switches, where each of the switches is connected to at least one slave device; and
the communication master device sends the broadcast search instruction, the broadcast access instruction, and the synchronization instruction to each of the slave devices through a switch connected to the slave device.

The present disclosure has following beneficial effects:

The present disclosure divides communication in a local area network into a device search stage, a device access stage, and a signal triggering stage. For instructions sent by a master device at different stages, a randomly generated timing time slice is specified for a slave device at the different stages, namely a first timing time slice, a second timing time slice, and a third timing time slice. This allows the slave device to respond to an instruction of the master device after timing of a corresponding timing time slice in a current stage ends, thereby staggering time for different slave devices to respond to the instruction and reducing a quantity of slave devices responding to the master device in a same time. This effectively reduces a probability of network congestion and data loss caused by making a response by a plurality of slave devices simultaneously.

### BRIEF DESCRIPTION OF THE DRAWINGS

To describe the technical solutions in the present disclosure more clearly, the drawings required to describe the implementations of the present disclosure are briefly described below. Apparently, the drawings described below are only some implementations of the present disclosure. Those of ordinary skill in the art may further obtain other drawings based on these drawings without creative efforts.

FIG. 1 is a schematic flowchart of a communication control method in a local area network according to an embodiment of the present disclosure; and

FIG. 2 is a schematic structural diagram of a communication control system in a local area network according to an embodiment of the present disclosure.

### DETAILED DESCRIPTION

The technical solutions of the embodiments of the present disclosure are clearly and completely described below with reference to the drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

In the embodiments of the present disclosure, a timing time slice (i.e., a first timing slot, a second timing slot, and a third timing slot) refers to a timing duration randomly generated by a slave device. The timing duration is assigned to a counter. When the count time of the counter equals the assigned timing duration (i.e., when timing of the timing time slice ends), the slave device performs a specific action.

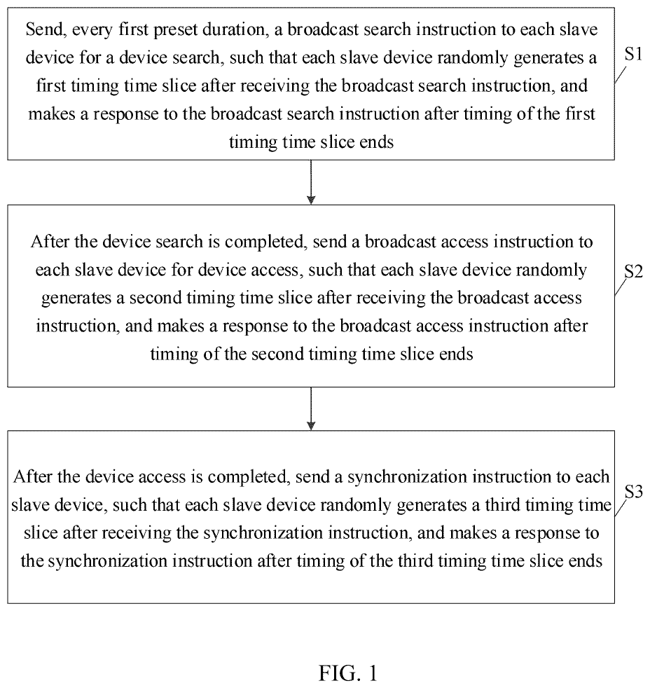

FIG. 1 is a schematic flowchart of a communication control method in a local area network according to an embodiment of the present disclosure. Referring to FIG. 1, the communication control method includes following steps.

Step S1: Send, every first preset duration, a broadcast search instruction to each slave device for a device search, whereby each slave device randomly generates a first timing time slice after receiving the broadcast search instruction, and makes a response to the broadcast search instruction after timing of the first timing time slice ends.

In a preferred embodiment, the first preset duration is duration from sending of the broadcast search instruction by a master device each time to sending of the broadcast search instruction next time. Specific duration may be set and adjusted based on a quantity of slave devices. For example, when there are 1000 slave devices in a system, the first preset duration may be set to 1 s. When there are 2000 to 5000 devices in the system, the first preset duration may be set to 2 s to 5 s. The first preset duration is flexibly set based on the quantity of slave devices in the system.

The first preset duration is flexibly set. This can minimize occurrence of a situation in which one first timing time slice randomly generated by each slave device has same timing duration as a first timing time slice of another slave device, in other words, can minimize a quantity of devices making a response simultaneously, thereby avoiding a network storm.

In a preferred embodiment, the master device records duration after the broadcast access instruction is sent, and ends a broadcast search for the slave device when the duration is greater than preset device response duration, where the preset device response duration is greater than the first preset duration. Alternatively, the master device ends a broadcast search for the slave device when the duration is less than preset device response duration but responses made by all slave devices to the broadcast access instruction have been received.

Specifically, when the system contains 1000 slave devices that need to respond to the search instruction sent by the master device, if a last slave device responds before the first preset duration ends, the search ends, and an access stage is entered.

Similarly, if the first preset duration is greater than the duration after the broadcast access instruction is sent, the search ends, and the access stage is entered.

In a preferred embodiment, the master device receives the response made by the slave device to the broadcast search instruction. After receiving the response made by the slave device to the broadcast search instruction, the master device records corresponding information of the slave device, and delivers a muting instruction to the slave device, whereby the slave device no longer responds to the broadcast search instruction sent by the master device after receiving the muting instruction.

For an illustrative purpose, assuming that there are currently 1000 slave devices in the system and the first preset duration is set to 1 s, the master device simultaneously sends the search instruction to these 1000 slave devices. In addition, each slave device receives the muting instruction from the master device after making a response. In this case, the slave device sets a muting flag after receiving the muting instruction and no longer respond to the search instruction sent by the master device.

Step S2: After the device search is completed, send a broadcast access instruction to each slave device for device access, whereby each slave device randomly generates a second timing time slice after receiving the broadcast access instruction, and makes a response to the broadcast access instruction after timing of the second timing time slice ends.

In the embodiments of the present disclosure, the broadcast access instruction is sent by the master device to the slave device, with the purpose of performing a data access operation on the slave device through the master device. The broadcast access instruction instructs the slave device to randomly generate the second timing time slice, and to makes a response to the broadcast access instruction after timing of the second timing time slice ends.

In a preferred embodiment, the communication control method further includes: receiving the response made by the slave device to the broadcast access instruction.

Assuming that there are currently 1000 slave devices in the system, the master device synchronously sends the broadcast access instruction to these 1000 slave devices. After receiving the broadcast access instruction, each slave device determines whether a response needs to be made. If the response needs to be made, each slave device randomly generates the second timing time slice, and makes the response to the broadcast access instruction after the timing of the second timing time slice ends.

Step S3: After the device access is completed, send a synchronization instruction to each slave device, whereby each slave device randomly generates a third timing time slice after receiving the synchronization instruction, and makes a response to the synchronization instruction after timing of the third timing time slice ends.

In the embodiments of the present disclosure, the synchronization instruction is sent by the master device to the slave device, with the purpose of performing operations such as data synchronization and time synchronization between the master device and the slave device. The synchronization instruction instructs the slave device to randomly generate the timing time slice and to makes a response to the synchronization instruction after timing of the third timing time slice ends.

In a preferred embodiment, the communication control method further includes: receiving the response made by the slave device to the synchronization instruction.

Assuming that there are currently 1000 slave devices in the system, the master device synchronously sends the synchronization instruction to these 1000 slave devices. After receiving the synchronization instruction, each slave device determines whether a response needs to be made. If the response needs to be made, each slave device randomly generates the third timing time slice, and makes the response to the synchronization instruction after the timing of the third timing time slice ends.

In a preferred embodiment, timing duration of the first timing time slice ranges from 1 ms to N ms, timing duration of the second timing time slice ranges from 1 ms to N ms, and timing duration of the third timing time slice ranges from 1 ms to Mms, where 1<M<N.

Specifically, in a synchronization stage of the slave device, when being triggered by a synchronization instruction, the slave device needs to respond to a host in a timely manner, which requires high real-time performance. Therefore, it is necessary to shorten the timing duration of the third timing time slice. For example, if the system requires the slave device to respond within 200 ms after receiving a broadcast triggering signal sent by the master device, the timing duration of the third timing time slice set by the slave device should be within 0 ms to 200 ms.

In a preferred embodiment, each slave device is connected to a corresponding switch, and each slave device receives the broadcast search instruction, the broadcast access instruction, and the synchronization instruction through the corresponding switch.

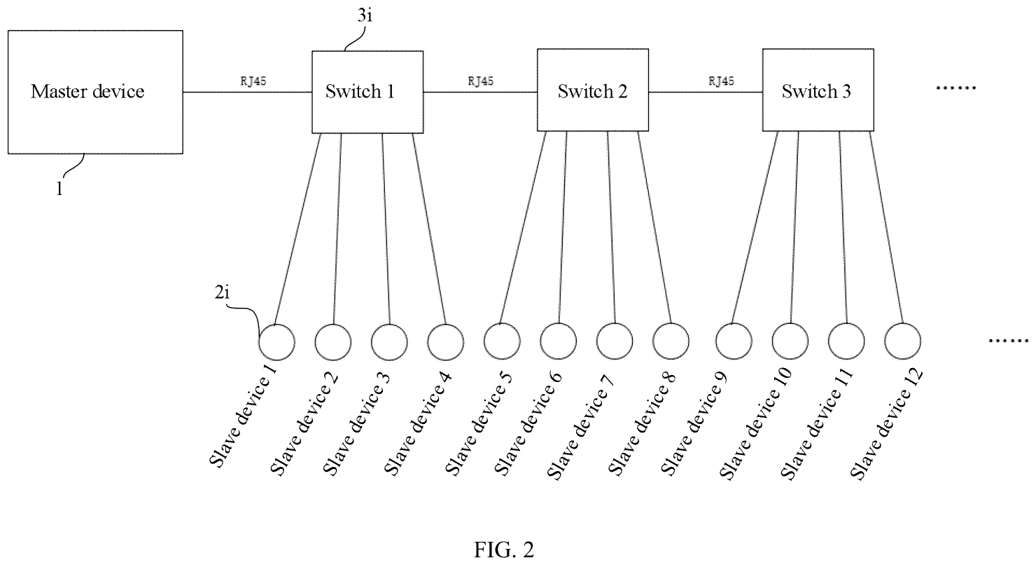

Further, FIG. 2 is a schematic structural diagram of a communication master device and a system in a local area network according to an embodiment of the present disclosure.

On a basis of the above method embodiments, another embodiment of the present disclosure further provides a communication master device in a local area network.

The communication master device includes a processor, a memory, and a computer program stored in the memory and configured to be executed by the processor. The processor executes the computer program to implement the communication control method in a local area network in the above embodiments of the present disclosure.

The processor may be a CPU, and may also be another general-purpose processor, a digital signal processor (DSP), an application specific integrated circuit (ASIC), a field-programmable gate array (FPGA) or another programmable logic device, a discrete gate, a transistor logic device, a discrete hardware component, or the like. The general-purpose processor may be a microprocessor, or any conventional processor. The processor is a control center of the communication master device, and various parts of the whole communication master device are connected by using various interfaces and lines.

The memory may be configured to store the computer program. The processor implements various functions of the communication master device by running or executing the computer program stored in the memory and invoking data stored in the memory. The memory may mainly include a program storage area and a data storage area. The program storage area may store an operating system, an application program required by at least one function, and the like. The data storage area may store data created based on use of a mobile phone, and the like. In addition, the memory may include a high-speed random access memory, and may further include a non-volatile memory, such as a hard disk, an internal storage, a plug-in hard disk, a smart media card (SMC), a secure digital (SD) card, a flash card, at least one magnetic disk storage device, a flash memory device, or another volatile solid-state storage device.

On a basis of the above communication master device, the present disclosure correspondingly provides a communication control system in a local area network including a communication master device, as shown in FIG. 2.

An embodiment of the present disclosure provides a communication control system in a local area network including a communication master device 1, including a communication master device1, and a plurality of slave devices 2i.

The communication master device 1 is configured to send, every first preset duration, a broadcast search instruction to each of the slave devices 2i for a device search.

Each of the slave devices 2i is configured to randomly generate a first timing time slice after receiving the broadcast search instruction, and make a response to the broadcast search instruction after timing of the first timing time slice ends.

A quantity of first timing time slices with same duration is less than a first preset quantity.

Further, the communication master device 1 is further configured to: record duration after the broadcast access instruction is sent, and end a broadcast search for the slave device 2i when the duration is greater than preset device response duration, where the preset device response duration is greater than the first preset duration; or end a broadcast search for the slave device 2i when the duration is less than preset device response duration but responses made by all the slave devices 2i to the broadcast access instruction have been received.

Further, the communication master device 1 is further configured to: receive the response made by the slave device 2i to the broadcast search instruction; and

after receiving the response made by the slave device 2i to the broadcast search instruction, record corresponding information of the slave device 2i, and deliver a muting instruction to the slave device 2i, whereby the slave device 2i no longer responds to the broadcast search instruction sent by the communication master device 1 after receiving the muting instruction.

The communication master device 1 is further configured to: after the device search is completed, send a broadcast access instruction to each of the slave devices 2i for device access.

Each of the slave devices 2i is further configured to randomly generate a second timing time slice after receiving the broadcast access instruction, and make a response to the broadcast access instruction after timing of the second timing time slice ends.

A quantity of second timing time slices with same duration is less than a second preset quantity.

The communication master device 1 is further configured to: after the device access is completed, send a synchronization instruction to each of the slave devices 2i.

Each of the slave devices 2i is further configured to randomly generate a third timing time slice after receiving the synchronization instruction, and make a response to the synchronization instruction after timing of the third timing time slice ends.

A quantity of third timing time slices with same duration is less than a third preset quantity.

Further, the communication control system in a local area network further includes a plurality of switches 3i. Each of the switches 3i is connected to at least one slave device 2i.

The communication master device 1 sends the broadcast search instruction, the broadcast access instruction, and the synchronization instruction to each of the slave devices 2i through a switch 3i connected to the slave device 2i.

The descriptions above are preferred implementations of the present disclosure. It should be noted that for a person of ordinary skill in the art, various improvements and modifications can be made without departing from the principles of the present disclosure. These improvements and modifications should also be regarded as falling into the protection scope of the present disclosure.

1. A communication control method in a local area network, comprising:
sending, every first preset duration, a broadcast search instruction to each slave device for a device search, whereby each slave device randomly generates a first timing time slice after receiving the broadcast search instruction, and makes a response to the broadcast search instruction after timing of the first timing time slice ends;
after the device search is completed, sending a broadcast access instruction to each slave device for device access, whereby each slave device randomly generates a second timing time slice after receiving the broadcast access instruction, and makes a response to the broadcast access instruction after timing of the second timing time slice ends; and
after the device access is completed, sending a synchronization instruction to each slave device, whereby each slave device randomly generates a third timing time slice after receiving the synchronization instruction, and makes a response to the synchronization instruction after timing of the third timing time slice ends.

2. The communication control method in a local area network according to claim 1, further comprising:
receiving the response made by the slave device to the broadcast search instruction; and
after receiving the response made by the slave device to the broadcast search instruction, recording corresponding information of the slave device, and delivering a muting instruction to the slave device, whereby the slave device no longer responds to the broadcast search instruction sent by a master device after receiving the muting instruction.

3. The communication control method in a local area network according to claim 2, further comprising: recording duration after the broadcast access instruction is sent, and ending a broadcast search for the slave device when the duration is greater than preset device response duration, wherein the preset device response duration is greater than the first preset duration; or ending a broadcast search for the slave device when the duration is less than the preset device response duration but responses made by all slave devices to the broadcast access instruction have been received.

4. The communication control method in a local area network according to claim 1, wherein timing duration of the first timing time slice ranges from 1 ms to N ms, timing duration of the second timing time slice ranges from 1 ms to N ms, and timing duration of the third timing time slice ranges from 1 ms to M ms, wherein 1<M<N.

5. The communication control method in a local area network according to claim 1, wherein each slave device is connected to a corresponding switch, and each slave device receives the broadcast search instruction, the broadcast access instruction, and the synchronization instruction through the corresponding switch.

6. A communication master device for a local area network, comprising a processor, a memory, and a computer program stored in the memory and configured to be executed by the processor, wherein the processor executes the computer program to implement the communication control method in a local area network according to claim 1.

7. A communication master device for a local area network, comprising a processor, a memory, and a computer program stored in the memory and configured to be executed by the processor, wherein the processor executes the computer program to implement the communication control method in a local area network according to claim 2.

8. A communication master device for a local area network, comprising a processor, a memory, and a computer program stored in the memory and configured to be executed by the processor, wherein the processor executes the computer program to implement the communication control method in a local area network according to claim 3.

9. A communication master device for a local area network, comprising a processor, a memory, and a computer program stored in the memory and configured to be executed by the processor, wherein the processor executes the computer program to implement the communication control method in a local area network according to claim 4.

10. A communication master device for a local area network, comprising a processor, a memory, and a computer program stored in the memory and configured to be executed by the processor, wherein the processor executes the computer program to implement the communication control method in a local area network according to claim 5.

11. A communication control system for a local area network, comprising a communication master device, and a plurality of slave devices, wherein
the communication master device is configured to send, every first preset duration, a broadcast search instruction to each of the slave devices for a device search;
each of the slave devices is configured to randomly generate a first timing time slice after receiving the broadcast search instruction, and make a response to the broadcast search instruction after timing of the first timing time slice ends;
the communication master device is further configured to: after the device search is completed, send a broadcast access instruction to each of the slave devices for device access;
each of the slave devices is further configured to randomly generate a second timing time slice after receiving the broadcast access instruction, and make a response to the broadcast access instruction after timing of the second timing time slice ends;
the communication master device is further configured to: after the device access is completed, send a synchronization instruction to each of the slave devices; and
each of the slave devices is further configured to randomly generate a third timing time slice after receiving the synchronization instruction, and make a response to the synchronization instruction after timing of the third timing time slice ends.

12. The communication control system for a local area network according to claim 7, wherein the communication master device is further configured to:
receive the response made by the slave device to the broadcast search instruction; and
after receiving the response made by the slave device to the broadcast search instruction, record corresponding information of the slave device, and deliver a muting instruction to the slave device, whereby the slave device no longer responds to the broadcast search instruction sent by the communication master device after receiving the muting instruction.

13. The communication control system for a local area network according to claim 8, wherein the communication master device is further configured to:
record duration after the broadcast access instruction is sent, and end a broadcast search for the slave device when the duration is greater than preset device response duration, wherein the preset device response duration is greater than the first preset duration; or end a broadcast search for the slave device when the duration is less than preset device response duration but responses made by all the slave devices to the broadcast access instruction have been received.

14. The communication control system for a local area network according to claim 9, further comprising a plurality of switches, wherein each of the switches is connected to at least one slave device; and
the communication master device sends the broadcast search instruction, the broadcast access instruction, and the synchronization instruction to each of the slave devices through a switch connected to the slave device.
